(19) United States
(12) Patent Application Publication
(10) Pub. No.: US 2008/0068128 A1
(43) Pub. Date: Mar. 20, 2008

(54) Keyless passive entry system

(76) Inventors: Riad Ghabra, Dearborn Heights, MI (US); Qingfeng Tang, Novi, MI (US); John S. Nantz, Brighton, MI (US); Hiroyuki Maeda, Canton, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/513,960

(22) Filed: Aug. 31, 2006

(51) Int. Cl. G05B 19/00; B60R 25/00

(52) U.S. Cl. 340/5.61; 340/5.72; 340/10.33

(57) ABSTRACT

A vehicle-based communication system for a vehicle includes a vehicle-based electronic control unit disposed within an interior structure of the vehicle for passively controlling entry to the vehicle. At least a portion of the vehicle-based electronic control unit and at least a portion of the interior structure are unshielded at low electromagnetic frequencies. A housing encloses the vehicle-based electronic control unit. A transmitter is disposed within the electronic control unit for generating a wake-up signal. A single antenna is integrated within the electronic control unit for transmitting the wake-up signal to a respective portable communication device exterior of the vehicle. The wake-up signal challenges the respective portable communication device for determining a presence of the portable communication device for allowing access to the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates in general to vehicle keyless entry systems, and more specifically, to vehicle keyless passive entry systems.

2. Background of Related Art

Passive entry keyless systems allow a user access to a vehicle without having to use a key to unlock a vehicle door or actuate a switch on a key fob. Typically the passive entry system operates by a driver or a passenger who is carrying a portable passive entry device (e.g., key fob) touches a door handle. The sensing of the user touching the door handle is sensed by either a capacitive sensor or other sensing device which initiates the transmittance of an electromagnetic signal (i.e., wake-up) signal broadcast by a plurality of LF frequency antennas packaged throughout the vehicle to the area around the vehicle. The portable passive entry device carried by the user upon receiving the wake-up call transmits a signal to an electronic communication module (e.g., electronic control unit) within the vehicle. The electronic communication module determines the validity of the signal transmitted by the passive device and unlocks the vehicle door if the signal is validated.

Typically, a plurality of LF antennas is mounted in various locations around the vehicle remote from the electronic communication module for transmitting wake-up signals from designated locations. These mounting locations include a driver side vehicle door or a driver side mirror for sensing the driver side of the vehicle, a passenger side vehicle door or a passenger side mirror for sensing the passenger side of the vehicle, and a trunk for sensing the trunk location. The plurality of antennas mounted remote from the vehicle-based electronic communication module require a communication line for coupling each respective antenna to a transmitter. Each additional antenna added to the passive entry system increases the cost of the passive entry system due to the added antenna, wiring, and mounts. In addition, packaging space must be designated for routing the wiring and for mounting the antennas.

### BRIEF SUMMARY OF THE INVENTION

The present invention has an advantage reducing the number of LF antennas mounted in a vehicle for a keyless passive entry system by integrating a single antenna within an electronic control unit and mounting the electronic control unit within center console of the instrument panel so that the wake-up signal broadcast by the LF antenna is broadcast to both sides of the vehicle.

A vehicle-based communication system for a vehicle includes a vehicle-based electronic control unit disposed within an interior structure of the vehicle for passively controlling entry to the vehicle. At least a portion of the vehicle-based electronic control unit and at least a portion of the interior structure are unshielded at low electromagnetic frequencies. A housing encloses the vehicle-based electronic control unit. A transmitter is disposed within the electronic control unit for generating a wake-up signal. A single antenna is integrated within the electronic control unit for transmitting the wake-up signal to a respective portable communication device exterior of the vehicle. The wake-up signal challenges the respective portable communication device for determining a presence of the portable communication device for allowing access to the vehicle.

A passive entry system for a vehicle includes a portable communication device carried by a user. A housing is mounted within the vehicle. A vehicle-based electronic control unit is mounted in the housing for communicating with the portable communication device. At least a portion of the vehicle-based electronic control unit and at least a portion of the interior structure are unshielded at low electromagnetic frequencies. The electronic control unit includes a printed circuit board having a controller, transmitter, and receiver for communicating with the portable communication device. A single antenna is integrated within the electronic control unit for broadcasting a wake-up signal to the portable communication device.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a system diagram of a prior art vehicular integrated remote keyless-passive entry system.

FIG. 2 is a system diagram of a vehicular integrated remote keyless-passive entry system of the present invention.

FIG. 3 is a schematic block diagram of the remote keyless-passive entry system of the present invention.

### DETAILED DESCRIPTION OF THE PREFERRED EMBODIMENT

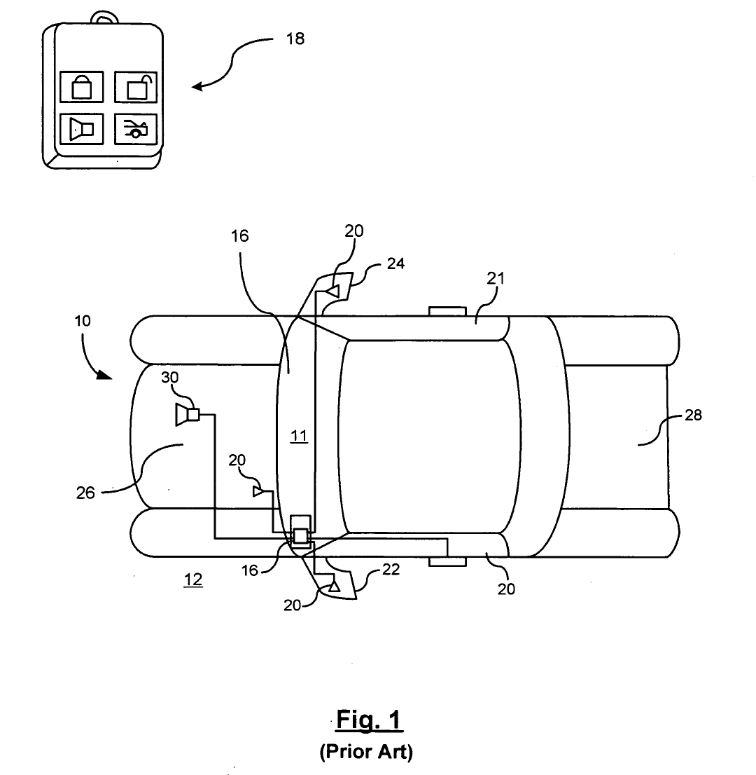

Referring to FIG. 1, there is shown a prior art passive entry system. A vehicle 10 includes an interior region 11 and an exterior region 12. A driver side vehicle door 13 and a passenger side vehicle door 14 provide a secured entry barrier between the interior region 11 and the exterior region 12 of the vehicle, and can be automatically unlocked by a passive entry system for allowing the user access to the interior region 11.

A vehicle-based electronic control unit (ECU) 16 for controlling passive entry functions is mounted within the vehicle structure of the vehicle 10 such as in a junction box 18 of the vehicle 10. The ECU 16 is coupled to a plurality of low frequency (LF) antennas 20 disposed at various locations of the vehicle for communicating with a portable communication device 18 that is typically carried by a user of the vehicle 10 for allowing the user access to the interior region 11 of the vehicle. The plurality of LF antennas 20 may be located in a driver side vehicle door 13, a passenger side vehicle door 14, a driver side mirror 22, a passenger side mirror 24, an engine compartment 26, or a trunk compartment 28. The plurality of LF antennas 20 are coupled to the ECU 16 via respective communication lines.

The portable communication device 18 is a portable electronic device that is capable of receiving an interrogation signal, such as a wake-up signal, from the ECU 16 and is responsive to the wake-up signal by broadcasting a response signal to the ECU 16. Preferably, the portable communication device 18 is a remote keyless entry (RKE) fob. The RKE fob typically broadcasts RF signals to a vehicle-based ECU 16 in response to a user actuating one of the plurality of switches commonly disposed on the face of the RKE fob for remotely actuating various vehicle entry functions such as unlocking and locking the vehicle doors, unlatching a trunk latch, or for activating and deactivating a vehicle alarm system 30.

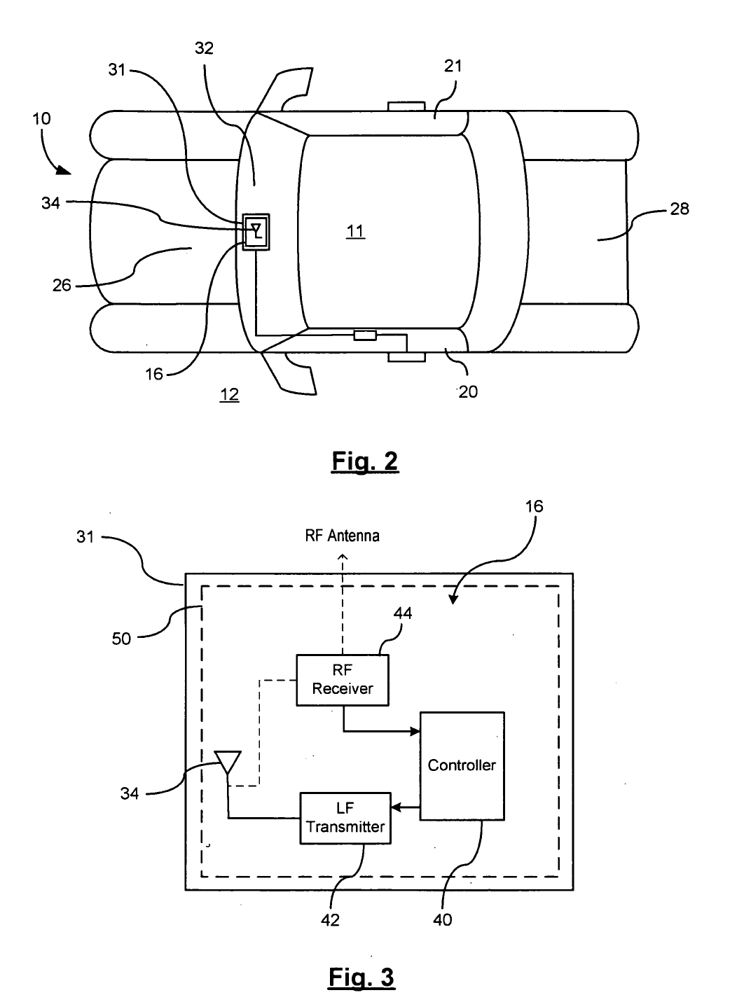

FIG. 2 illustrates a vehicle integrating the passive entry system of the present invention. The ECU 16 is disposed within a housing 31 that is mounted in a central location within a vehicle instrument panel 32. The ECU 16 includes a single antenna 34 disposed therein. Preferably, the single antenna is a LF antenna. Positioning the ECU 16 centrally within the instrument panel 32 allows the single antenna 34 to transmit equally to both the driver's side of the vehicle and the passenger's side of the vehicle. As a result of centrally packaging of the ECU 16 having the single antenna 34 disposed therein, the number of LF antennas shown in FIG. 1, such as the plurality of LF antennas 20 mounted in the driver side mirror 22, the passenger side mirror 24, and the engine compartment 26, may be reduced. Alternatively, the ECU 16 may be selectively mounted in the engine compartment 26 or a trunk compartment 28.

The ECU 16 is enclosed by the housing 31 for protecting the ECU 16 from environmental conditions and debris. Preferably, the housing 31 is produced from a plastic or similar material which does not interfere or at least a portion of the housing 31 does not interfere with the broadcast of the signals to and from the ECU 16. Moreover, the housing 31 is mounted within the interior region structure 11 such that the interior structure or at least a part of the interior structure thereof is unshielded at low electromagnetic frequencies for allowing the broadcast of the communication between the ECU 16 and the exterior region 12 of the vehicle 10.

FIG. 3 illustrates a schematic block diagram of a preferred embodiment of the passive entry system. The vehicle-based ECU 16 includes a microcontroller 40 coupled to a LF transmitter 42 and a RF receiver 44. A RF transmitter (not shown) may be included if the portable communication device 18 and the ECU 16 support 2-way communication or if the ECU 16 communicates wirelessly to other devices within or outside of the vehicle 10.

The LF transmitter 42 is coupled to the single antenna 34 disposed within the ECU 16. Preferably, the single antenna 34 is integrated within a printed circuit board 50 of the ECU 16. Integrating the single antenna 34 within the ECU 16 eliminates the requirement for additional wiring which would be required to couple the LF transmitter 42 to the single antenna 34. The RF receiver may be coupled to an RF antenna disposed external to the ECU. In an alternative embodiment, the both the LF transmitter 42 and the RF receiver 44 are coupled to the single antenna 34 for transmitting LF signals and receiving RF signals.

The wake-up signal generated by the LF transmitter 42 and broadcast by the LF antenna 34 typically has a transmission range of 2.5 m. Locating the ECU 16 centrally within the center console of the instrument panel 16 (shown in FIG. 1) allows the signal to be broadcast substantially equally on both sides of the vehicle for energizing the LF receiver 56 of the portable communication device 18 carried by the user at either the driver side passenger vehicle door 20 or the passenger side vehicle door 21 (shown in FIG. 1). Integrating the LF antenna 34 onto the printed circuit board 50 within the ECU 16, as described earlier, eliminates a communication line which would ordinarily couple the LF transmitter 42 and the LF antenna 34. Furthermore, packaging space that would otherwise be designated for wire routing or mounting the antenna is eliminated. In addition, the elimination of wiring to various locations of the vehicle also eliminates any potential electromagnetic interferences which may occur with other electrical devices or electrical wires packaged within close proximity to a respective communication line coupling a respective remote LF antenna to the ECU 16. By centrally locating the ECU 16 (having the LF antenna 34 integrated therein) within the center console of the instrument panel 16 (shown in FIG. 1), the need for additional LF antennas are reduced since a centrally positioned LF antenna could adequately broadcast the wake-up signal to each side of the vehicle 10.

Referring to FIGS. 1-3, the operation of the passive entry system will be described herein. A user approaches the driver side vehicle door 20 or the passenger side vehicle door 21 and touches the respective door handle. A proximity sensor (not shown) or other type of sensing apparatus detects the user and a wake-up signal is generated by the controller 40 of the ECU 16 and is broadcast by the transmitter 42 and LF antenna 34 integrated within the ECU 16 to the surrounding area.

The portable communication device 18 carried by the user includes an LF receiver (not shown) coupled to a LF antenna (not shown) and a microcontroller (not shown) for receiving the wake-up signal from the ECU 16. An omni directional antenna is commonly used so that the wake-up signal broadcast by the ECU 16 may be detected by the LF antenna within the portable communication device 18 regardless of the orientation of the portable communication device 18; however, a 2D or a one dimensional antenna may be used. Preferably, the wake-up signal includes a preamble followed by a patterned signal. If the patterned data of the broadcast wake-up signal matches the data stored in the portable communication device 18, the microcontroller within the portable communication device 18 is woken up. Energizing the microcontroller only after the determination that matching data patterns are present assists in maintaining the longevity of the battery (not shown) that powers the microcontroller. Alternatively, the wake-up signal may not be patterned and the microcontroller may waken each time an energy field of sufficient magnitude or random noise is present.

The portable communication device 18 carried by the user attempting to access the vehicle 10 receives and validates the wake-up signal. Upon validation, the microcontroller within the portable communication device 18 will be fully energized. The microcontroller within the portable communication device 18 will control the broadcast of a response signal to the ECU 16 in the vehicle 10 in response to the receiving the wake-up signal.

The response signal broadcast by the portable communication device 18 is received by the RF receiver 44 of the ECU 16. The authenticity of the response signal is determined by the controller 40 of the ECU 16. If the controller 42 determines the response signal is valid, then the controller 40 commands a door control module (not shown) to unlock the corresponding vehicle door.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle-based communication system for a vehicle, said system comprising:
a vehicle-based electronic control unit disposed within an interior structure of said vehicle for passively controlling entry to said vehicle, at least a portion of said vehicle-based electronic control unit and at least a portion of said interior structure being unshielded at low electromagnetic frequencies;
a housing for enclosing said vehicle-based electronic control unit;
a transmitter disposed within said electronic control unit for generating a wake-up signal; and
a single antenna integrated within said electronic control unit for transmitting said wake-up signal to a respective portable communication device exterior of said vehicle, said wake-up signal challenging said respective portable communication device for determining a presence of said portable communication device for allowing access to said vehicle.

2. The system of claim 1 wherein said single antenna is integrated on a printed circuit board of said electronic control unit.

3. The system of claim 1 wherein said single antenna is a low frequency (LF) antenna and said wake-up signal is a LF signal.

4. The system of claim 1 wherein said electronic control unit is disposed within an interior passenger compartment of said vehicle.

5. The system of claim 4 wherein said electronic control unit is disposed within a center console instrument panel.

6. The system of claim 5 wherein said electronic control unit is centrally disposed within said center console instrument panel.

7. The system of claim 1 wherein said electronic control unit is disposed within said engine compartment.

8. The system of claim 1 wherein said electronic control unit is disposed with said trunk.

9. The system of claim 1 wherein said electronic control unit is disposed within a vehicle door panel.

10. The system of claim 1 further comprising a RF receiver coupled to said single antenna wherein said single antenna receives RF signals.

11. A passive entry system for a vehicle comprising:
a portable communication device carried by a user;
a housing mounted within said vehicle;
a vehicle-based electronic control unit mounted in said housing for communicating with said portable communication device, at least a portion of said vehicle-based electronic control unit and at least a portion of said interior structure being unshielded at low electromagnetic frequencies, said electronic control unit comprising:
a printed circuit board including a controller, transmitter, and receiver for communicating with said portable communication device; and
a single antenna integrated within said electronic control unit for broadcasting a wake-up signal to said portable communication device.

12. The system of claim 11 wherein said single antenna is integrated on a printed circuit board of said electronic control unit.

13. The system of claim 11 wherein said single antenna is a low frequency (LF) antenna and said wake-up signal is a LF signal.

14. The system of claim 11 wherein said electronic control unit is disposed within an interior passenger compartment of said vehicle.

15. The system of claim 14 wherein said electronic control unit is disposed within a center console instrument panel.

16. The system of claim 15 wherein said electronic control unit is centrally disposed within said center console instrument panel.

17. The system of claim 11 further comprising a RF receiver coupled to said single antenna wherein said single antenna receives RF signals.
